(19) United States
(12) Patent Application Publication
(10) Pub. No.: US 2005/0102883 A1
(43) Pub. Date: May 19, 2005

(54) Remote control bobber

(76) Inventor: Richard Temes, West Chicago, IL (US)

Correspondence Address: MCCRACKEN & FRANK LLP, 200 W. ADAMS STREET, SUITE 2150, CHICAGO, IL, 60606, US

(21) Appl. No.: 10/779,225

(22) Filed: Feb. 14, 2004

Related U.S. Application Data
(63) Continuation-in-part of application No. 10/717,324, filed on Nov. 19, 2003, now abandoned.

(51) Int. Cl. A01K 93/00

(52) U.S. Cl. 43/26.1; 43/44.87

(57) ABSTRACT

A radio transmitter send signals to a radio receiver that in turn controls a fishing bobber having a housing and motors mounted within the housing. The motors are connected to propellers. The receiver can control the speed and direction of the bobber.

### CROSS REFERENCE TO RELATED APPLICATIONS

This application is a continuation in part of Ser. No. 10/717,312, filed Nov. 19, 2003.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to remotely controlled devices and more specifically to a radio controlled fishing bobber.

2. Description of the Background of the Invention

There have been a number of devices developed over the years to assist an angler in pursuit of fish. For instance, U.S. Pat. No. 4,339,888 discloses a remote control fishing device that carries a fishing line to a particular point and drop/retrieve the line. U.S. Pat. No. 6,397,510 shows a fishing bobber with electronics to sense a striking fish. U.S. Pat. No. 6,389,736 describes a fishing bobber with adjustable gravity. U.S. Pat. No. 5,463,597 describes a fish locator bobber device.

### SUMMARY OF THE INVENTION

One aspect of the present invention comprises a remote control bobber that includes a housing that is buoyant in water and a motor mounted within the housing having a shaft that extends through the housing. A propeller is mounted on the shaft outside the housing, a receiver is mounted within the housing, the receiver including an antenna and a control circuit to control the motor; and a power supply is connected to the motor and the receiver.

A further aspect of the present invention comprises a remote control bobber that includes a housing that is buoyant in water, a motor mounted within the housing having a shaft that extends through the housing, and a propeller mounted on the shaft outside the housing. A receiver is mounted within the housing; the receiver includes an antenna and a control circuit to control the motor. A power supply is connected to the motor and the receiver and a fish-locating device is mounted within the housing.

A still further embodiment of the present invention comprises a remote control bobber that includes a housing that is buoyant in water, a drive motor mounted within the housing having a shaft that extends through the housing, and a propeller mounted on the shaft outside the housing. A receiver is mounted within the housing, the receiver includes an antenna and a control circuit to control the drive motor and a power supply is connected to the drive motor and the receiver. A mounting structure capable of attachment to a line is mounted to one side of the housing; and a line control motor is mounted within the housing at a side opposite the mounting structure to raise and lower a fishing line, the line control motor being connected to the power supply and to the receiver.

Other aspects and advantages of the present invention will become apparent upon consideration of the following detailed description.

### BRIEF DESCRIPTION OF THE DRAWINGS

FIG. 1 is a side view of one embodiment of the present invention;

FIG. 2 is a rear view of the embodiment of FIG. 1;

FIG. 3 is a schematic diagram showing an arrangement of the internal components of FIG. 1;

FIG. 4 is a schematic diagram showing the relationship of the transmitter to internal components shown in FIG. 3;

FIG. 5 is a side view of a further embodiment of the present invention;

FIG. 6 is a rear view of the embodiment of FIG. 6;

FIG. 7 is a schematic diagram showing an arrangement of the internal components of FIG. 5;

FIG. 8 is a rear view of the exterior of a still further embodiment of the present invention;

FIG. 9 is a view of the embodiment of FIG. 8 taken substantially along the line 9-9;

FIG. 10 is schematic diagram showing an arrangement of the internal components of FIG. 8;

FIG. 11 is a side view of a fourth embodiment of the present invention;

FIG. 12 is a rear view of the embodiment of FIG. 11;

FIG. 13 a schematic diagram showing an arrangement of the internal components of FIG. 11;

FIG. 14 is a side view of a fifth embodiment of the present invention partially broken away to show interior detail;

FIG. 15 is a rear view of the embodiment of FIG. 14;

FIG. 16 a schematic diagram showing an arrangement of the internal components of FIG. 14;

FIG. 17 is a schematic diagram showing the relationship of the transmitter to internal components shown in FIG. 14;

FIG. 18 a schematic diagram showing an arrangement of the internal components of a sixth embodiment of the present invention; and

FIG. 19 is a schematic diagram showing the relationship of the transmitter to internal components shown in FIG. 18.

### DETAILED DESCRIPTION OF THE DRAWINGS

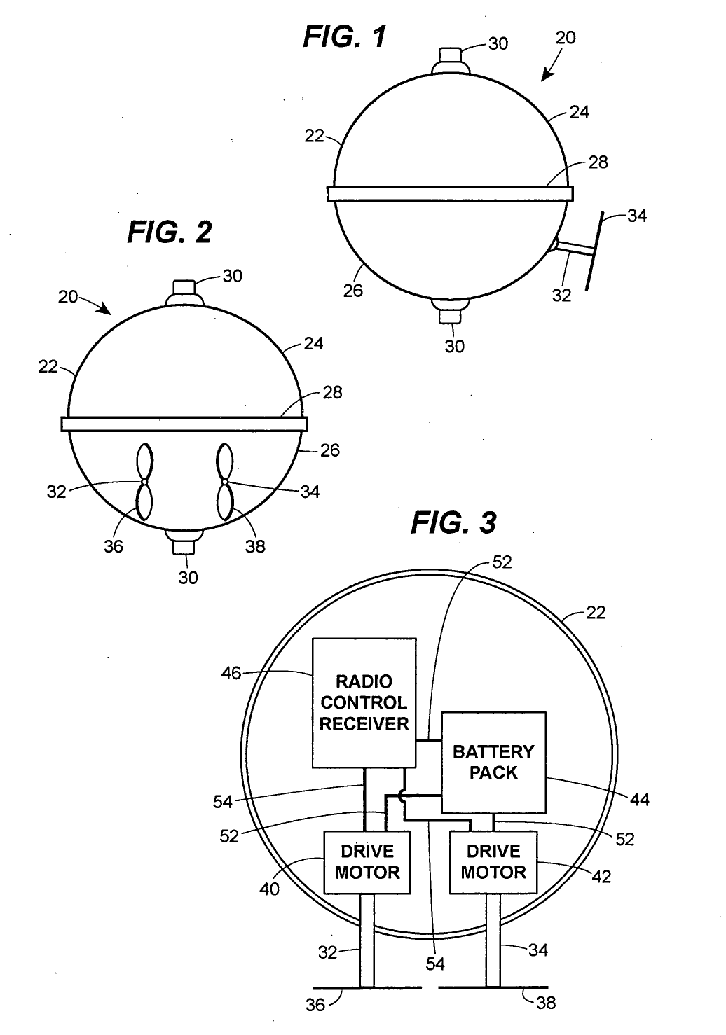

Referring to FIGS. 1 to 4, one embodiment of the remote controlled bobber 20 of the present invention has a housing 22. The housing 22 comprises a first section 24 and a second section 26. The first section 24 and the second section 26 are joined to each other at a central band 28. The first section 24 and the second section 26 can be joined in any conventional manner. For instance, the first section 24 and the second section 26 can be permanently affixed to each other at the central band 28 using conventional adhesives, molded undercuts, or welding techniques. Alternatively, if it will be necessary to have access to the interior of the bobber 20, the first section 24 and the second section 26 can be removably attached to each other at the central band 28. The method of attaching the first section 24 to the second section 26 should form a watertight seal. For instance, an O-ring (not shown) can be placed within the central band 28 to form a watertight seal.

Attached to the exterior of either or both of the first section 24 and the second section 26 of the housing 22 are quick release connectors 30. The connectors 30 can be any conventional design and can be attached to the housing 22 by conventional methods. The quick release connectors provide a connection point for the bobber 20 to a fishing line (not shown) and rod (not shown) at one end and the fishing line and hook (not shown) on the other end. A first propeller shaft 32 protrudes through the second section 26 of the housing 22. A second propeller shaft 34 also protrudes through the second section 26 of the housing 22. Both the first and second propeller shafts 32 and 34 have a conventional seal so that no water will enter the housing 22. The first and second propeller shafts 32 and 34 are attached to a first and a second propeller 36 and 38. The first and the second propellers 36 and 38 both propel the bobber through the water and also provide for directional control. A first and a second motor 40 and 42 are connected to the first and second propeller shafts 32 and 34. The first and second motors 40 and 42 can be independently controlled and can be reversible so that one motor can operate in a forward direction and the other motor can operate in reverse. This enables the bobber 20 to be maneuvered into the desired position by the angler. The first and second motors 40 and 42 are connected both to a battery pack 44 that provides power to the first and second motors 40 and 42 by electrical conductors 52.

Control conductors 54 also connect a radio receiver 46 to the first and second motors 40 and 42. The electrical conductors 52 also connect the receiver 46 to the battery pack 44. The control conductors 54 provide signal control to each of the first motor 40 and the second motor 42 independently. A radio transmitter unit 48 can send control signals to an antenna 50 attached to the receiver 46, which in turn provides control to each of the first motor 40 and the second motor 42. The antenna 50 can be completely contained within the housing 22. Any conventional radio controlled transmitter and receiver can be used. Typical receivers of the type used in radio controlled airplanes and cars can be used. These transmitters and receivers operate at a radio frequency of about 27 MHz, although other frequencies can be used. The transmitter 48 typically will have dual controls 56 and 58 to independently control the first and second motors 40 and 42. Since there may be other anglers using a remote control bobbers near by, provision can be made to encode the radio signals so that a particular transmitter 48 and bobber 20 pair will not interfere with or be interfered by a radio transmitter used by another angler. The transmitter 48 can also include a video screen (not shown) for use with certain embodiments of the present invention.

The housing 22 can be contrasted of any suitable watertight material that can be molded into a desired shape, such as plastic. In addition, the bobber 20 is sealed in a watertight manner as described above and also includes a significant amount of free space within the housing 22. This provides buoyancy to the bobber 20 so that it will float. The weight of the components contained within the housing 22 is typically located within the second section 24 so that the bobber will float upright. The housing 22 can be any desired shape such as spherical or egg shaped.

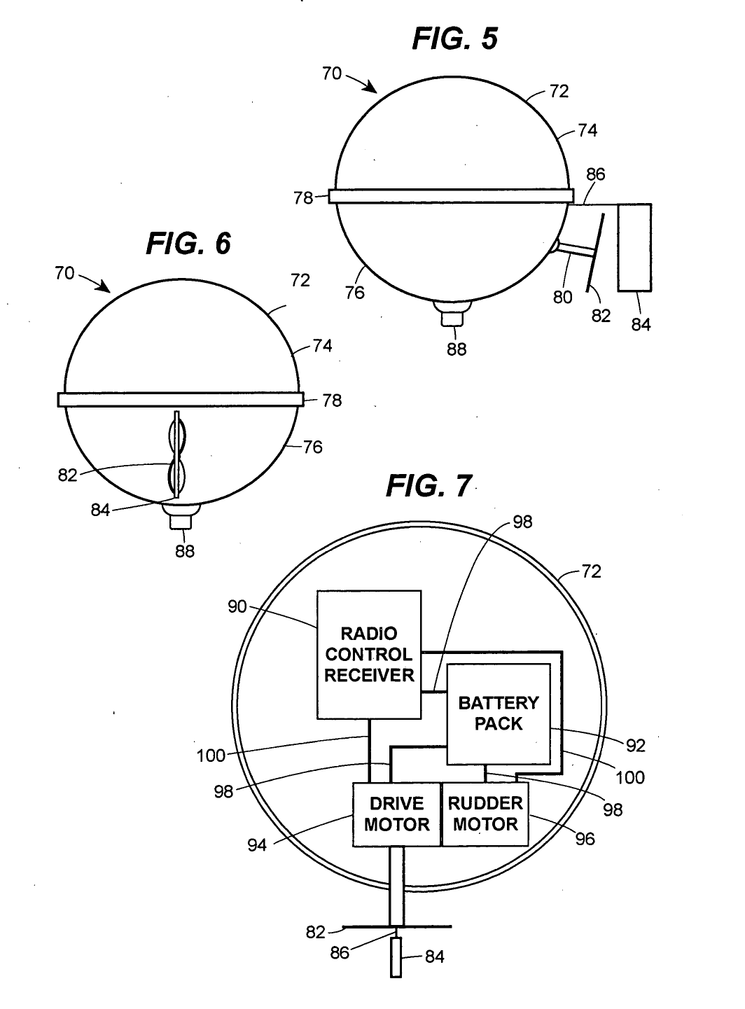

Referring to FIGS. 5 to 7, a second embodiment of a bobber 70 is shown. The bobber 70 has a housing 72 having a first section 74, a second housing 76, and a central band 78 similar to the first section 24, the second section 26, and the central band 28 of the embodiment shown in FIG. 1. The bobber 70 has a single propeller shaft 80 attached to a propeller 82 and a rudder 84 and a rudder shaft 86. The propeller shaft 80 and the propeller 82 are similar to the similar parts shown in FIG. 1. Attached to the housing 72 is a quick release connector 88. While a single connector 88 is shown in FIGS. 5 and 6, multiple connectors 88 can be used if desired.

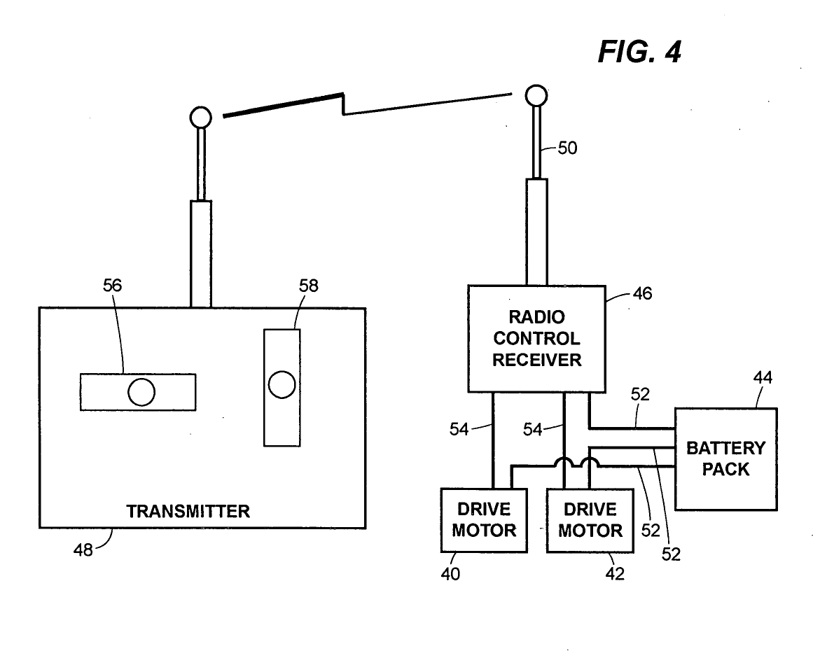

A radio receiver 90 similar to receiver 46 described above is contained and mounted within the housing 72 in a conventional manner. The receiver 90 is connected to a battery pack 92 using electrical conductors 98. The battery pack is also connected to a first motor 94 that drives the propeller shaft 80 to provide power to the first motor 94. Control conductors 100 are connected from the receiver 90 to the first motor 94 to control the direction and speed of the first motor 94. Also located within the housing 72 is a second motor 96 that is attached to the rudder shaft 86. The second motor or servo unit 96 is also connected to the battery pack 94 and to the receiver 94 by electrical conductors 98 and control conductors 100 respectively. The receiver 94 can control second motor 96 to provide directional control to the bobber 70. The transmitter 48, as shown in FIG. 4, controls the receiver 94 in the same manner as described above.

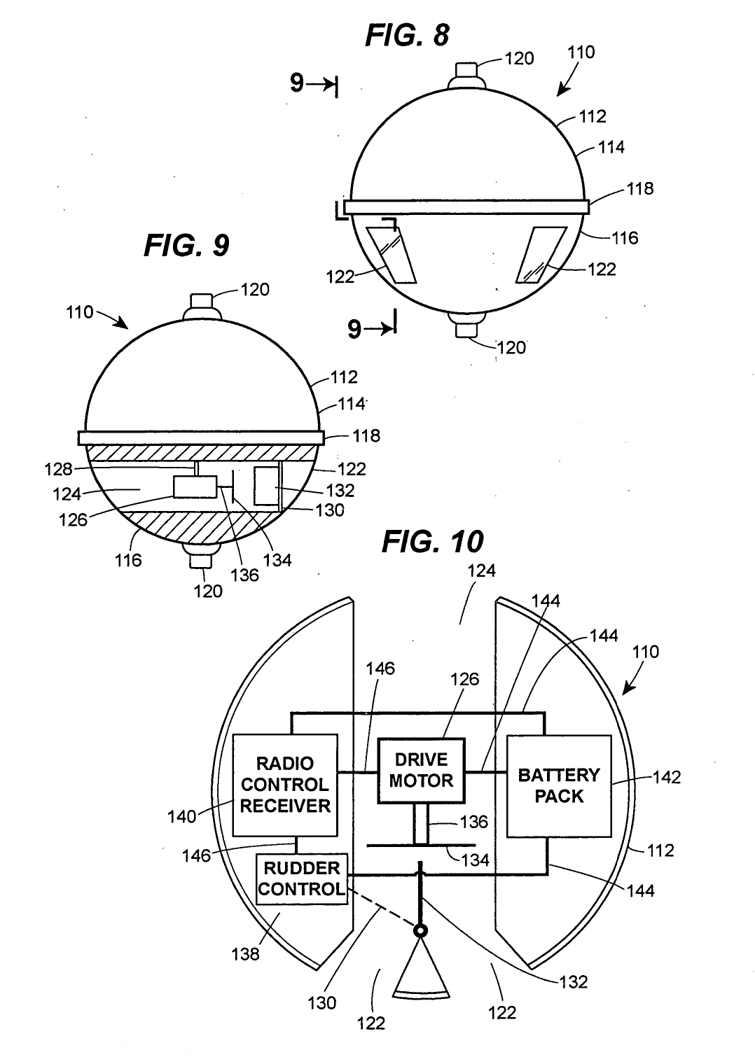

FIGS. 8 to 10 show a third embodiment of a bobber 110. The bobber 110 has a housing 112 with a first section 114 and a second section 116. A central band 118 joins the first and second sections 114 and 116. The first section 114 and the central band 118 are similar to the first section 24 and the central band 28 described above. Quick release connectors 120 are connected to both the first and the second section 114 and 116. The second section 116 has a pair of exits 122 of a channel 124 that passes through the interior of the second section 116. A motor 126 is mounted using a mounting bracket 128 within the channel 124. Also mounted on a rudder shaft 130 within the channel 124 is a rudder 132. The motor 126 is attached to a propeller 134 by a propeller shaft 136. The rudder shaft 130 is connected to a rudder control motor 138. This connection is shown as a dotted line in FIG. 10 and can be made by any conventional linkage. Electrical conductors 140 connect a radio receiver 142 to a battery pack 144. The battery pack 144 is also connected to the motor 126 and the rudder control motor 138 by electrical controllers 140. The receiver 142 controls the motor 126 and the rudder control motor 138 by control conductors 146. The transmitter 48, as shown in FIG. 4, controls the receiver 142 in the same manner as described above. The electrical conductors 140 and the control conductors 146 are attached to the mounting bracket 128 to provide power and control to the motor 126.

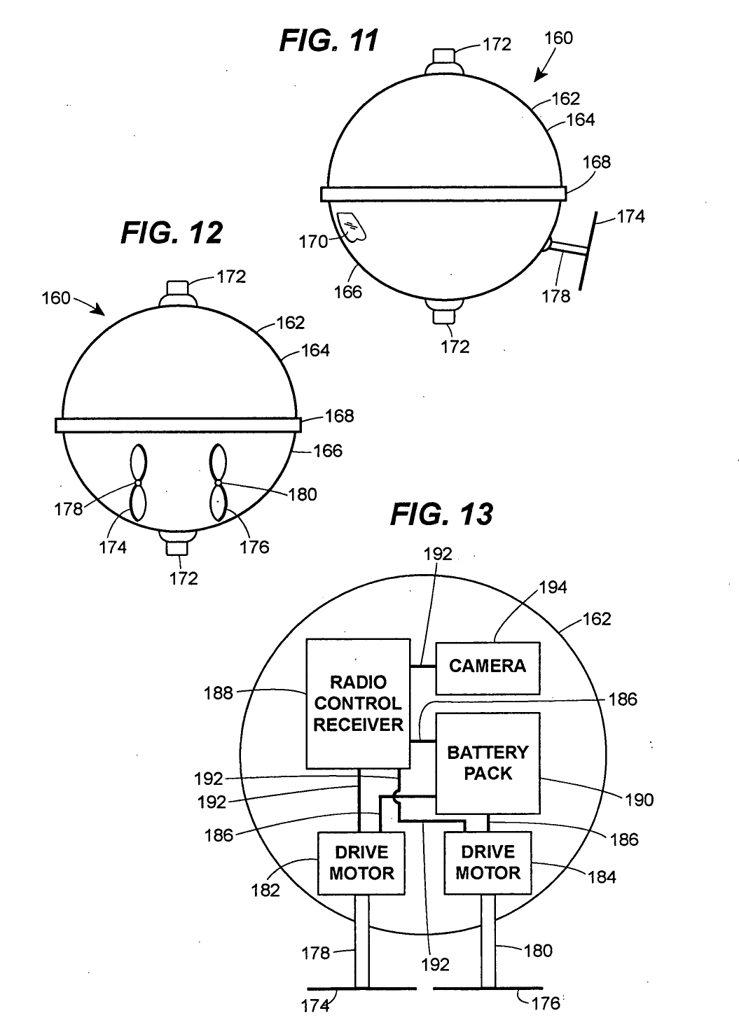

FIGS. 11 to 13 illustrate a further embodiment of a bobber 160. The bobber 160 has a housing 162 with a first section 164 and a second section 166. A central band 168 joins the first and second sections 164 and 166. The first section 164 and the central band 168 are similar to the first section 24 and the central band 28 described above. Quick release connectors 172 are connected to both the first and the second section 164 and 166. The second section 166 has a window or transparent area 170 in the end of the second section 166 opposite a first and second propellers 174 and 176. The first and second propellers 174 and 176 are connected to first and second propeller shafts 178 and 180. The first and second propeller shafts are connected to a first and second motor 182 and 184, respectively. The first and second motors 182 and 184 are mounted within the housing 162 in the same manner as the first and second motors 40 and 42 described above. Electrical conductors 186 connect a receiver 188 to a battery pack 190 in the same manner as described above. In a similar manner, the receiver 188 controls the first and second motors 182 and 184 using control conductors 192. A camera 194 is mounted within the housing using conventional mounting methods so that the lens of the camera 194 can look through the window 170. The transmitter 48, as shown in FIG. 4, controls the receiver 188 in the same manner as described above. The camera 194 can transmit images back to the receiver 48. The camera 194 can provide the angler with a view of direction of travel of the bobber 160 if the bobber 160 is out of direct line of sight.

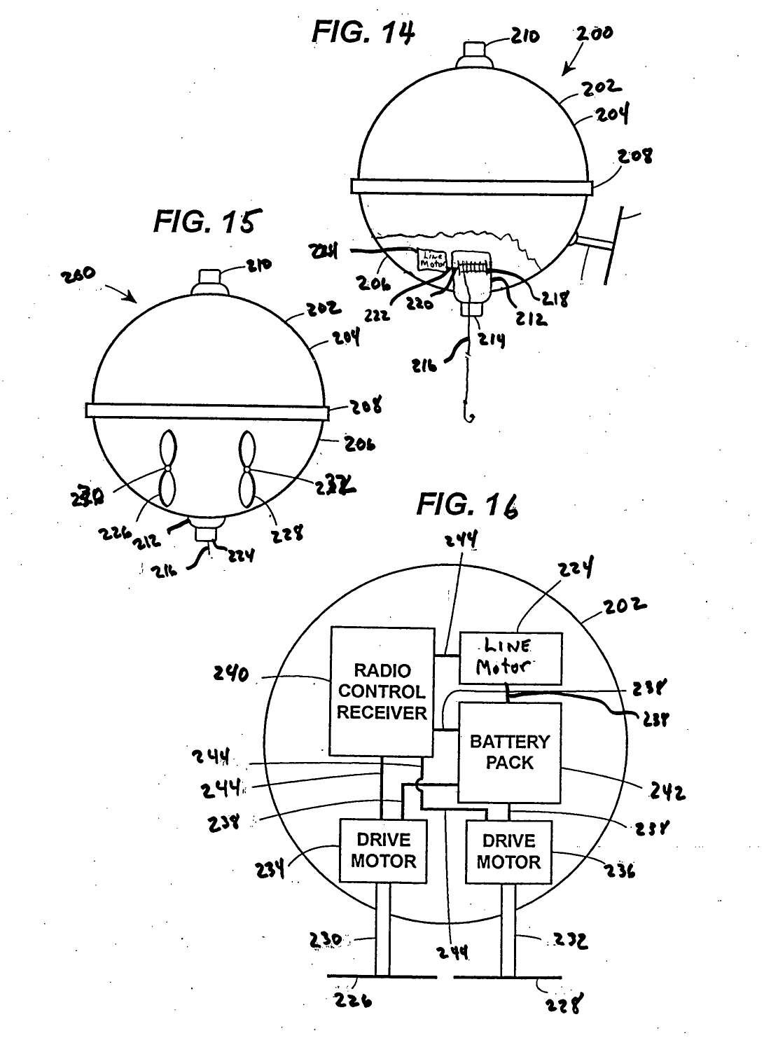

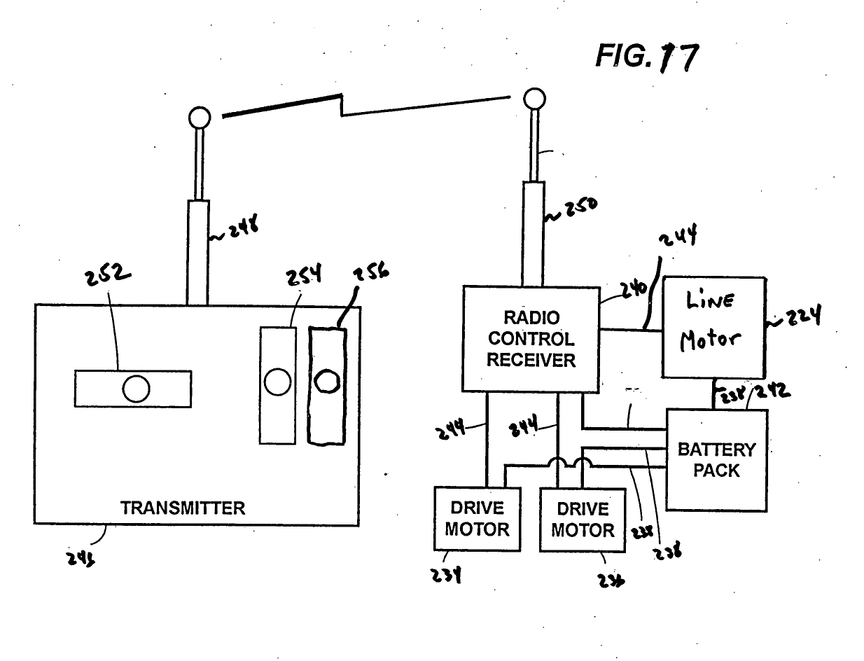

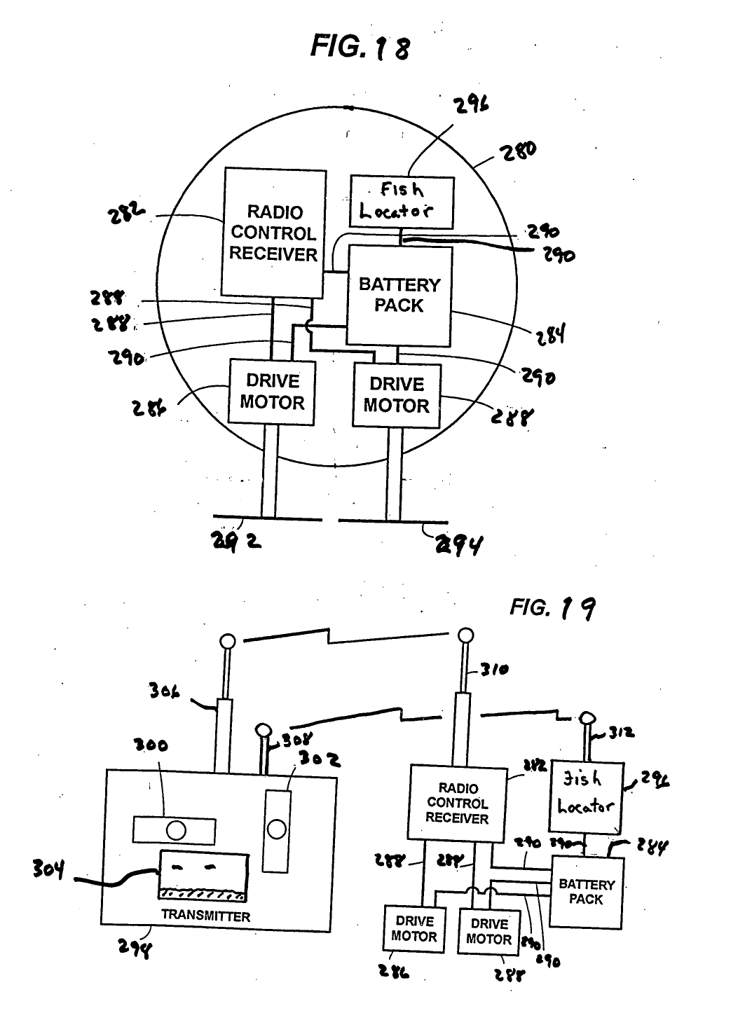

FIGS. 14 to 17 illustrate another embodiment of a bobber 200. The bobber 200 has a housing 202 with a first section 204 and a second section 206. A central band 208 joins the first and second sections 204 and 206. The first and second sections 204, 206, and the central band 208 are similar to the first and second sections 24, 26, and the central band 28 described above. A quick release connector 210 is connected to the first section 204. The second section 206 has a watertight internal compartment 212 that has an opening 214 to allow a fishing line 216 to pass into and out of the second section 206. The opening 214 is on a side of the housing opposite from the quick release connector 210. A spool 218 is mounted on a shaft 220. The shaft 220 passes through the watertight internal compartment 212 at a watertight bearing 222. The shaft 220 is driven to a line drive motor 224.

A first and second propellers 226 and 228 are connected to first and second propeller shafts 230 and 232. The first and second propeller shafts 230, 232 are connected to a first and second motor 234 and 236, respectively. The first and second motors 234 and 236 are mounted within the housing 202 in the same manner as the first and second motors 40 and 42 described above and drive the first and second propeller 226 and 228. Electrical conductors 238 connect a receiver 240 to a battery pack 242 in the same manner as described above. In a similar manner, the receiver 240 controls the first and second motors 234 and 236 using control conductors 244. The line motor 224 is mounted within the second section 206 in a conventional manner. The line motor 224 is connected to the battery pack 242 using the electrical connectors 238 and to the receiver 240 using the control conductor 244. The transmitter 246, as shown in FIG. 4, controls the receiver 240 through antennae 248 and 250. The antenna 250 can be mounted internally within the housing 202. The transmitter 246 has three controls 252, 254 and 256. The controls 252 and 254 control the first and second motors 234 and 236 through the receiver 240 in the same manner as described above. The control 256 controls the line motor 224 through the receiver 240 in a manner similar to the first and second motors 234 and 236. When the control 256 is actuated, the line motor 224 either takes up or releases the fishing line 216 to raise a lower a fishing took or lure 258 through the opening 214 to an appropriate depth.

FIGS. 18 and 19 illustrate a sixth embodiment of a bobber 280 of the present invention. The bobber 280 appears in all respects similar to the bobber 20 shown in FIG. 1. Mounted within the bobber 280 is a receiver 282, a battery 284, a first and second motor 286 and 288 and control connectors 288 and electrical conductors 290. The first and second motors 286 and 288 drive a first and second propeller 292 and 294. A fish locator device 296 is also mounted within the bobber 280. The fish locator device 296 can be any know type of locator device such as a sonar device well know in the art. The housing of the bobber 280 should be made from a material that will not interfere with the transmission of signals from the fish locator device 296. The battery 284 provides power to the fish locator 296 through the electrical conductor 290. The transmitter 298 has a first and second controller 300 and 302 and a display window 304. The transmitter also has a first and second antennae 306 and 308. The antenna 306 communicates with an antenna 310 associated with the receiver and the antenna 308 communicates with an antenna 312 associated with the fish locator 296. The fish locator 296 will enable the angler to maneuver the bobber 280 into position to more efficiently catch fish. It is also possible that the bobber 280 also can include the fishing line drive mechanism shown in FIGS. 14 to 17.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications that come within the scope of the appended claims are reserved.

1. A remote control bobber comprising:
a spherical housing that is buoyant in water;
a first motor mounted within the housing having a first shaft that extends through the housing;
a propeller mounted on the first shaft outside the housing;
a second motor mounted within the housing having a second shaft that extends through the housing;
a second propeller mounted on the second shaft;
a receiver mounted within the housing, the receiver including an antenna mounted within the housing and a control circuit to control the first motor and a separate control circuit to control the second motor; and
a power supply connected to the first motor, the second motor, and the receiver.

2. The remote control bobber of claim 1 wherein the housing includes a mounting structure capable of attachment to a line.

3. (canceled)

4. The remote control bobber of claim 1 wherein a transmitter activated by a user controls the receiver.

5. (canceled)

6. The remote control bobber of claim 1 wherein the housing has a rudder that is controlled by a servo contained within the housing.

7. (canceled)

8. A remote control bobber comprising:
a spherical housing that is buoyant in water;
a first motor mounted within the housing having a first shaft that extends through the housing;
a propeller mounted on the first shaft outside the housing;
a second motor mounted within the housing having a second shaft that extends through the housing;
a second propeller mounted on the second shaft;
a receiver mounted within the housing, the receiver including an antenna mounted within the housing and a control circuit to control the first motor and a separate control circuit to control the second motor;
a power supply connected to the first motor, the second motor, and the receiver; and
a fish locating device mounted within the housing.

9. The remote control bobber of claim 8 wherein the housing includes a mounting structure capable of attachment to a line.

10. (canceled)

11. The remote control bobber of claim 8 wherein a transmitter activated by a user controls the receiver.

12. (canceled)

13. The remote control bobber of claim 8 wherein the housing has a rudder that is controlled by a servo contained within the housing.

14. The remote control bobber of claim 8 wherein a line control motor is mounted within the housing to raise and lower a fishing line, the line control motor being connected to the power supply and to the receiver.

15. A remote control bobber comprising:
a spherical housing that is buoyant in water;
a first motor mounted within the housing having a first shaft that extends through the housing;
a propeller mounted on the first shaft outside the housing;
a second motor mounted within the housing having a second shaft that extends through the housing;
a second propeller mounted on the second shaft;
a receiver mounted within the housing, the receiver including an antenna mounted within the housing and a control circuit to control the first motor and a separate control circuit to control the second motor;
a power supply connected to the first motor, the second motor, and the receiver;
a mounting structure capable of attachment to a line mounted to one side of the housing; and
a line control motor is mounted within the housing at a side opposite the mounting structure to raise and lower a fishing line, the line control motor being connected to the power supply and to the receiver.

16. (canceled)

17. (canceled)

18. The remote control bobber of claim 8 wherein a transmitter activated by a user controls the receiver.

19. (canceled)

20. The remote control bobber of claim 15 wherein the housing has a rudder that is controlled by a servo contained within the housing.
